(19) United States
(12) Patent Application Publication
(10) Pub. No.: US 2022/0172278 A1
(43) Pub. Date: Jun. 2, 2022

(54) Shared Shopping System

(71) Applicant: Blue Yellow Green Inc., Venice, CA (US)

(72) Inventor: William Anzevino, Los Angeles, CA (US)

(21) Appl. No.: 17/541,055

(22) Filed: Dec. 2, 2021

Related U.S. Application Data
(60) Provisional application No. 63/120,647, filed on Dec. 2, 2020.
(60) Provisional application No. 63/150,492, filed on Feb. 17, 2021.

(51) Int. Cl. G06Q 30/06

(52) U.S. Cl. CPC G06Q 30/0643; G06Q 30/0623; G06Q 30/0633

(57) ABSTRACT

A server conducts a shared shopping session according to interactions with a sales associate (SA) device and a shopper device. The SA device may be connected to cameras for streaming vide of the SA presenting products. The SA may invoke adding of products and checkout for the shopper. The shopper may pre-select products for the shared shopping session. A shared shopping session may include multiple objects merged together and may be scheduled by coordinating scheduling of an SA, units of one or more products, a venue, and the shopper. The SA may control the shared shopping session using gestures and receive real-time feedback.

### RELATED APPLICATIONS

The present disclosure is part of a non-provisional patent application claiming the priority benefit of U.S. Patent Application No. 63/120,647, filed on Dec. 2, 2020, and U.S. Patent Application No. 63/150,492, filed on Feb. 17, 2021, both of which are incorporated by reference in their entirety.

### BACKGROUND

### Field of the Invention

This invention relates to computerized systems for facilitating online shopping.

### Background of the Invention

A modern retailer must have a presence on the internet to survive. The amount of purchasing activity that is performed online continues to increase. Online sales have the advantage of enabling the purchaser to browse a large array of products and have them shipped to the purchaser's door. Webpages for products offered for sale online offer a large amount of information include a product description, reviews, and related products.

Although online sales provide access to a large amount of products and information, this benefit can become a detriment. Navigating all of this information can be confusing and may still leave a consumer with unanswered questions. Sometimes, only physical inspection of a product will do, particularly for articles of clothing and other fashion accessories.

It would be an advancement in the art to provide an improved approach for performing online sales.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a diagram illustrating a network environment in accordance with an embodiment of the present invention;

FIG. 1B is a diagram illustrating an interface for a shared shopping session in accordance with an embodiment of the present invention;

FIG. 1C is a diagram illustrating an interface for scheduling shared shopping sessions in accordance with an embodiment of the present invention;

FIG. 2 is a process flow diagram of a method for initiating a shared shopping session in accordance with an embodiment of the present invention;

FIG. 3 is a schematic block diagram of data structures for performing shared shopping in accordance with an embodiment of the present invention;

FIG. 4 is a schematic block diagram of components for managing a shared shopping session in accordance with an embodiment of the present invention;

FIG. 5 is a process flow diagram of a method for scheduling shared shopping sessions in accordance with an embodiment of the present invention;

FIG. 6 is a process flow diagram of a method for merging components that are part of a shared shopping session in accordance with an embodiment of the present invention;

FIG. 7 is a schematic block diagram of electronic shopping carts for a shared shopping session in accordance with an embodiment of the present invention;

FIG. 8 is a process flow diagram of a method for controlling streaming of video for a shared shopping session in accordance with an embodiment of the present invention;

FIG. 9 is a process flow diagram of a method for generating product recommendations in accordance with an embodiment of the present invention;

FIG. 10 is a schematic block diagram of an interface for initiating a shared shopping session in accordance with an embodiment of the present invention;

FIG. 11 is a schematic block diagram illustrating an example computing device suitable for implementing methods in accordance with embodiments of the present invention.

### DETAILED DESCRIPTION

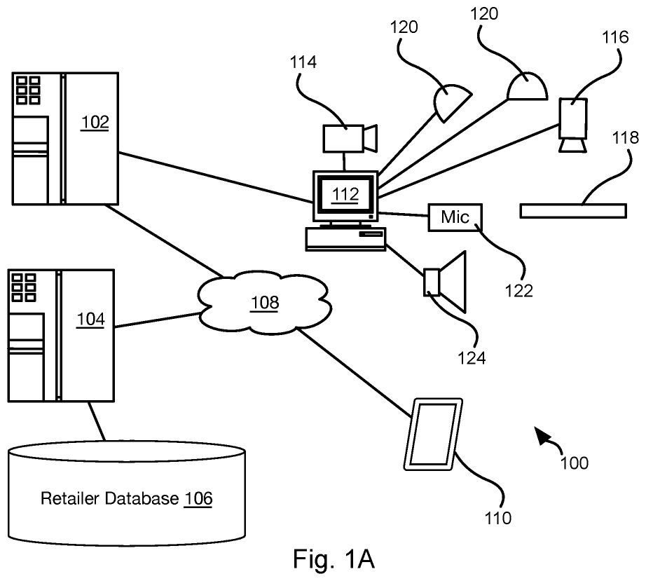

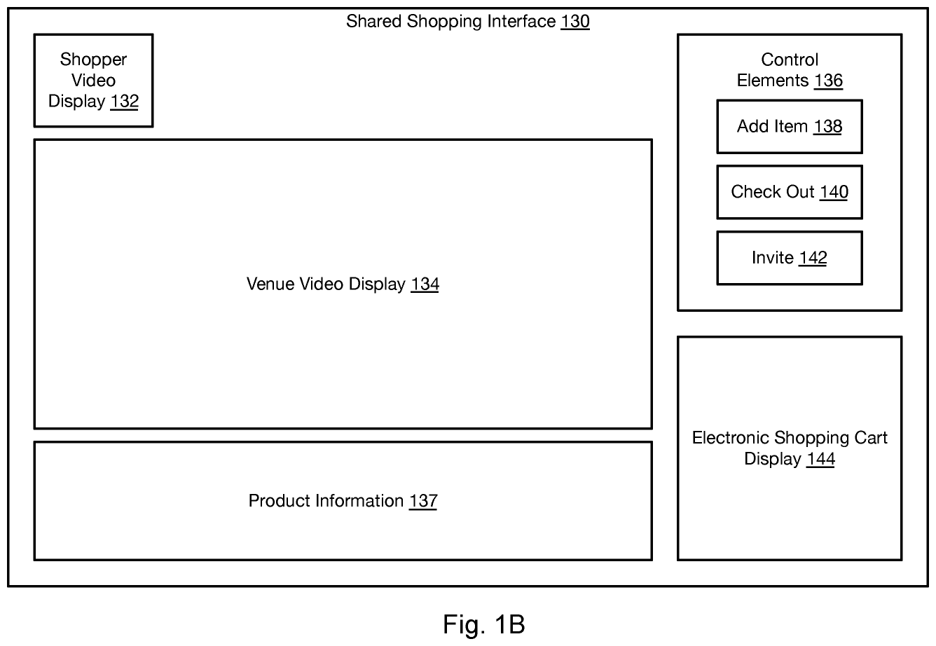

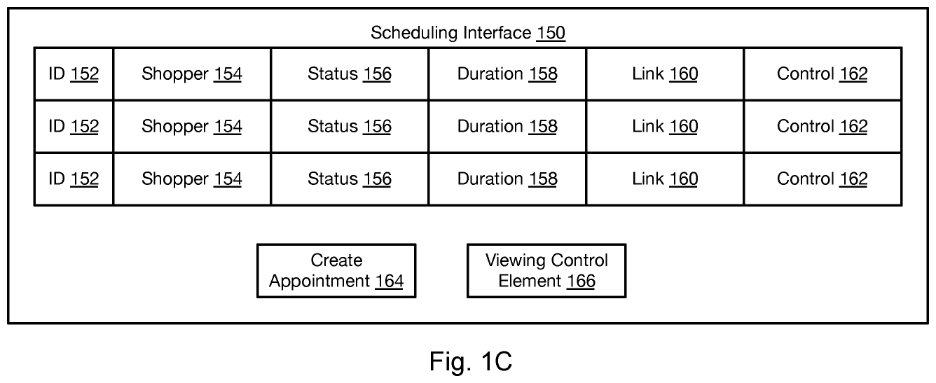

Referring to FIG. 1A, a network environment 100 may include a server system 102. The server system 102 may implement shared shopping in accordance with the methods disclosed herein. The server system 102 may interact with a retailer server system 104. The retailer server system 104 may host or access a retailer database 106. The database 106 may store product records containing descriptions of products, inventory levels at various locations, and other information. The database 106 may be used by the server system 102 to provide shared shopping for products referenced by the retailer database 106. In some embodiments, the shared shopping according to the systems and methods described herein may be provided by a retailer such that the server system 102 is omitted and the server system 104 alone is used. Accordingly, descriptions of functions performed by the server system 102 may be understood to be performable in a like manner by the retailer server system 104.

The server system 102 and server system 104 may communicate with one another by means of a network 108. The network 108 may include one or more wired or wireless connections and may include a local area network (LAN), wide area network (WAN), the Internet, or other type of network.

User computing devices 110 may connect to the server system 102 and the server system 104 by means of the network 108 in order to participate in shared shopping sessions as described herein. User computing devices 110 may also access the retailer database 106, such as by using a browser to request webpages presenting a visual representation of product records stored in the database 106. The user computing devices 110 may be desktop or laptop computers, smart phones, tablet computers, smart televisions, wearable computers, or any other type of computing devices.

The server system 102 may be in data communication with a sales associate (SA) device 112. The SA device 112 may be a desktop or laptop computer, smart phone, tablet computer, wearable computer, or any other type of computing device. The SA device 112 may be coupled to a wide angle camera 114 and a close up camera 116. As used herein, “coupled” shall be understood to refer to a wired or wireless connection capable of transmitting data. The camera 114 may be positioned, oriented and configured to capture an image of at least the face, torso, and arms of a sales associate participating in shared shopping according to the methods disclosed herein. The camera 116 may be positioned, oriented, and configured to capture images of an object placed on a planar support surface 118, such as a table, desk, or c']ounter. For example, the outermost lens of the camera 116 may be between 15 and 50 cm from the surface 118. Any number of other cameras with different fields of view and properties may also be used. The cameras may be three-dimensional cameras and the user computing device 110 may include means for displaying three-dimensional images, such as a holographic display, virtual-reality headset, or the like.

Various lights 120 may be present in a venue housing the cameras 114 and possibly the SA computing device 112. The lights 120 may be coupled to the SA computing device 112 such that inputs received through the SA computing device 112 may be used to control operation of the lights 120, such as turning the lights 120 on and off, adjusting the intensity of the lights 120 and/or adjusting the color or temperature spectrum of the lights 120. In some embodiments, one or more lights 120 illuminate the sales associate when standing in the field of view (FOV) of the camera 114 whereas one or more other lights 120 illuminate the FOV of the camera 116.

A microphone 122 and speaker 124 may also be coupled to the computing device 112. The microphone 122 and speaker 124 may be combined into a single device, such as a headset or wireless headphones with built in microphone.

The SA device 112 may include physical buttons or a touch screen enabling the sales associate to switch between cameras and manage adding of products to the shopping cart of a shared shopping session, invoking checkout, or performing other actions described herein as being performed by the sales associate.

Hereinafter, actions performed by a “shopper” shall be understood to be performed in response to inputs to the user device 110 through an interface to the server system 102 and provided to the server system 102 over the network 108. Information received from the shopper and information provided to the shopper shall be understood to be received from or sent to the user device 110.

Hereinafter, actions performed by a “sales associate” shall be understood to be performed in response to inputs to the SA device 112 through an interface to the server system 102 and provided to the server system 102 over a network. Information received from the sales associate and information provided to the sales associate shall be understood to be received from or sent to the SA device 112.

FIG. 1B illustrates a shared shopping interface 130. The shared shopping interface 130 may be displayed on the SA device 112 and/or user computing device 110. The shared shopping interface may be implemented as a webpage rendered by a browser of the user computing device 110. Updates to content for display in the webpage may be received from the server system 102. Interactions with the interface 130 may be transmitted for processing to the server system 102 from the SA computing device 112 and user computing device 110.

The shared shopping interface 130 may include a first video display 132 that is a thumbnail image of the output of a camera locally (e.g., within 3 meters) connected to the device 110, 112 on which the first video display 132 is displayed. The thumbnail may be between 1×1 cm and 10×10 cm when displayed on the display of the device 110, 112 on which it is displayed. In the case of the user device, the first video display 132 may display a stream of video from a camera mounted to the device 110, such as a built in camera on the device 110. For the SA device 112, the first video display 132 may display the output of one or both of the cameras 114, 116. For example, the first video display 132 may display the output of whichever of the cameras 114, 116 is selected to be transmitted to the user computing device 110.

The shared shopping interface 130 may include a second video display 134. The second video display 134 may display a video feed from a remote camera. In the case of the user computing device 110, the second video display 134 may display video streamed from one or more of the cameras 114, 116 at the shopping venue. In the case of the SA computing device 112, the second video display 134 may display video streamed from a camera of the user computing device 110. The second video display 134 may display streaming video in conjunction with output of audio streamed from the same device from which the streaming video was received.

The shared shopping interface 130 may include one or more control elements 136. The control elements 136 displayed on the SA computing device 112 may be different from those displayed on the user computing device 110. Examples of control elements may include a user interface element 138 for adding items to an electronic shopping cart, a user interface element 140 for invoking checkout (e.g., processing payment), a user interface element 142 for inviting one or more other entities to join a shared shopping session, and/or other user interface elements. For example, one or more interface elements for browsing a product catalog may be included in the shared shopping interface 130 as presented on either of the user computing device 110 and the SA computing device 112.

Other control elements 136 may control aspects of the shared shopping session such as starting or stopping sharing of streaming video, muting a microphone, ending the shared shopping session, switching between cameras 114, 116, or other aspects of the shared shopping session.

The control elements 136 may be dynamic. For example, as a product is being presented by a sales associate, the control elements 136 may invoke display of product information 137 for that product and user interface elements to view additional information about the product as well as interface elements 138, 140 to invoke adding of the product to the electronic shopping cart and purchasing the product. For the sales associate, the interface 130 may include control elements 136 that enable the sales associate to invoke display of product information 137 on the interface 130 of the shopper.

The control elements 136 in the interface 130 of the shopper and/or sales associate may include interface elements enabling the user of the interface 130 to browse product records and select products for discussion during the shared shopping session.

The shared shopping interface 130 may further include a display 144 of an electronic shopping cart 144. This may list images, text, and or prices from product records of products added to the electronic shopping cart 144. In some embodiments, the shared shopping interface 130 displayed to the SA and/or the shopper may enable the user of the interface 130 to add items to the electronic shopping cart and invoke checkout for the electronic shopping cart.

The interface 130 presented to the user and/or sales associate may be programmed to receive an input from a pointing device to drag and drop an image of a product from a location and superimposes the image of the product on the video display 134 of the shared shopping interface 130 presented to the shopper. The location may be on the desktop, another browser window, or other location on the display of the user and/or sales associate. The image may remain on the video display 134 and this process may be repeated such that there are multiple images that may be viewed and browsed, such as in a carousel arrangement.

FIG. 1C illustrates a scheduling interface 150. The scheduling interface 150 may be displayed to a sales associate on the SA device 112 or a different computing device. The scheduling interface 150 may include display a plurality of entries that each correspond to a shared shopping session according to the systems and methods disclosed herein.

Each entry for a shared shopping session may include an identifier 152 of the shopping session, an identifier 154 of the shopper (which may be blank if a shopper has not signed up yet and may reference multiple shoppers), a status 156 of the shared shopping session (unscheduled, scheduled, in-progress, ended, etc.), a scheduled duration 158 of the shared shopping session (which may include a start time), a link 160 (e.g., a link that may be input to a browser to enter the shared shopping session), and one or more other controls 162. The controls 162 may include controls for sharing the link 160, starting the shared shopping session, ending the shared shopping session, rescheduling the shared shopping session, adding additional participants to the shared shopping sessions, or other functions. Executable code for implementing the actions associated with the controls may be executed by the server system 102 in response to user interaction with the controls 162. When shared with the shopper, the link 160 may be associated with an image or video feed displayed to the shopper in the interface 130, website, or other interface.

In some embodiments, the interface 150 may include other control elements such as an element 164 to invoke creation of a shared shopping appointment. For example, element 164 may invoke presentation of an interface for receiving data for the fields 152-158 of a shared shopping session entry. A control element 166 may be provided in the interface 150 for changing viewing. The control element 166 may, for example, enable to a shopping assistant to instruct the server system 102 which entries to show in the interface 150, e.g., all appointments, appointments scheduled today, past appointments, or appointments matching particular keywords received through the control element 166.

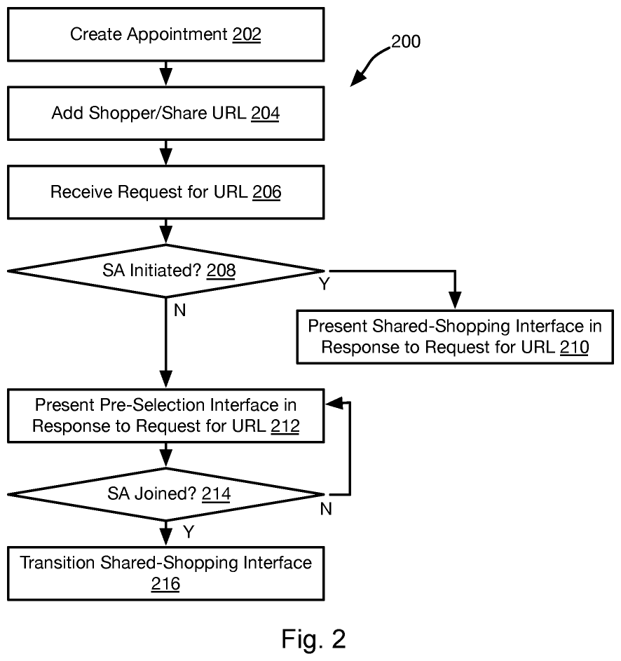

Referring to FIG. 2, the method 200 may be executed by the server system 102. The method 200 may include creating 202 a shared shopping session, such as for performing shared shopping according to any of the approaches described herein. Creating 202 the shared shopping session may be performed using the interface 150. Creating 202 the shared shopping session may be performed in response to instructions received from the sales associate (SA). The method 200 may including a step of either (a) adding 204 a shopper to the appointment or (b) sharing a link (e.g., URL) to the appointment. For example, the session may be a data structure referencing an identifier of the sales associate such that the sales associate or other user having the URL may initiate the session. In some embodiments, adding a shopper to the session will invoke sending a message to the shopper, e.g., via email, text, etc.

The method 200 may include receiving 206 a request for the URL from the shopper and evaluating 208 whether the sales associate has initiated the shared shopping session. Initiating the shared shopping session may include the sales associate instructing the server system 102 to present the shared shopping interface 130 for the shared shopping session on the SA device 112. The sales associate may do so by selecting a control element of an entry representing the shared shopping session in the interface 150. If the sales associate is found 208 to have initiated the shared shopping session, then the server system 102 presents 210 the shared shopping interface 130 on the user device 110 in response to receiving 206 the request for the URL. The shared shopping interface may be the shopper's version of the shared-shopping interface with the display 134 showing video data from one of the cameras 114, 116 described herein.

If the sales associate has not initiated the shared shopping session prior to receiving 206 the request for the URL, the method 200 may include presenting 212 a pre-selection interface to the shopper. The pre-selection interface may be an interface for searching products, listing products, selecting products to view product pages, and adding products to a shopping cart that the sales associate will be able to access according to the approach described herein. The pre-selection interface may implement any approach known in the art for enabling a user to search, browse, view, and select product records as known in the art. References to product records selected during presentation 212 of the pre-selection interface may be added to a data structure referencing product records to be discussed during the shared-shopping session.

When the sales associate is found 214 to have joined the shared shopping session, the interface presented to the shopper by the server system 102 may transition 216 to the shared shopping interface 130 described above. The shopper and sales associated may then proceed to conduct a shared shopping session as described herein.

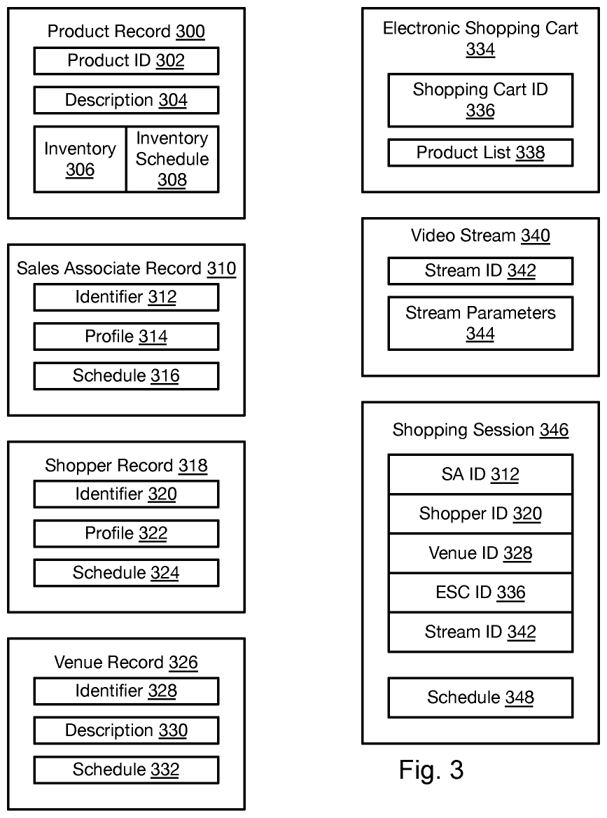

FIG. 3 is a schematic block diagram of data structures that may be used to implement a shared shopping session. These data structures may include product records 300 for products presented and discussed during the shared shopping session. A product record 300 for a product may include a unique product identifier 302 and a description 304 of the product. The description may include text, images, video, audio, or other data describing the product. The product record 300 may further include inventory data 306 indicating the number of units of the product and locations of these units. The product record may further include an inventory schedule 308 indicating when and where units of the product are needed for shared shopping sessions.

The data structures may include sales associate records 310 for a plurality of sales associates. The sales associate record 310 for a sales associate may include an identifier 312 of the sales associate, a profile 314 of the sales associate (e.g., image, name, associated store location(s), interests, etc.), and a schedule 316 of the sales associate (e.g., date, time, and location of shared shopping sessions scheduled for the sales associate and date, time, and/or location at which the sales associate is available to schedule shared shopping sessions).

The data structures may include a shopper record 318 for a plurality of shoppers. The shopper record for a shopper may include an identifier 320 of the shopper, a profile 322 of the shopper (e.g., image, name, residence location, preferences, shopping history, search history, etc.), and a schedule 324 of the shopper (e.g., date, time, and location of shared shopping sessions scheduled by the shopper). The profile 322 of the shopper may be particularly detailed and may include any approach for characterizing the attributes and preferences of a shopper as known in the art.

Note that in-person visits may also be scheduled by a shopper such that the schedule 324 includes one or both of online and in-person shared shopping appointments. In-person shared shopping sessions may be scheduled in the same manner as online-only sessions and may be preceded by pre-selection of products in the same manner. In-person sessions may be conducted in the same except that streaming of video to and from the shopper device 110 may be omitted and an interface 130 is presented only to the sales associate. Alternatively, the shopper device 110 may be mobile such that an interface 130 is still presented on the shopper device 110 during in-person shared shopping sessions.

The data structures may include venue records 326 corresponding to a plurality of venues. Each venue may be a retail location, or a portion of a retail location. For example, each SA computer 112 that is capable of performing a shared shopping session (such as in combination with any of the peripherals 114-124 described above) may have a corresponding venue record 326. The venue record 326 for a venue may include a unique identifier 328 of the venue, a description 330 (e.g., address, location within a building, list of available peripherals 114), and a schedule 332 (e.g., date and time of shared shopping sessions scheduled to take place at that venue and date, time, and/or location at which the venue is available for shared shopping sessions).

The data structures may include an electronic shopping cart 334 for each shared shopping session. As discussed below, a shared shopping session may include multiple shopping carts 334. Shopping carts 334 may also be created for non-shared shopping sessions. A shopping cart 334 may include an identifier 336 and a list 338 of product identifiers 302. For each product identifier 302 in the list 338, a quantity may also be listed. Other descriptors, such as size, color, or other attribute may also be included for each product identifier 302.

The data structures may include a video stream 340 for each camera used in each shared shopping session, or each camera that is currently active in each shared shopping session. Each video stream 340 may include a stream identifier 342 and may include one or more stream parameters 344, such as a source of the stream (address of the source computer), an encoding scheme (e.g., MP4), one or more frames of the stream that are buffered, or any other parameter known in the art for representing and managing a stream of audio-visual data.

The data structures may include a shared shopping session 346. The shared shopping session 346 may include identifiers of other entities associated with the shared shopping session 346, these may include one more sales associate identifiers 312, one or more shopper identifiers 320, a venue identifier 328, one or more electronic shopping cart identifiers 336, and one or more stream identifiers 342. Where multiple electronic shopping carts 334 are used in a shared shopping session, each electronic shopping cart 334 may be associated with a specific shopper identifier 320 of the shopping identifiers 320 associated with the shared shopping session 346.

A shared shopping session 346 may further include schedule data 348 indicating a time and data for which the shared shopping session 346 is scheduled. In some embodiments, a shared shopping session 346 may be created and populated with the identifiers of other entities as they are associated with the shared shopping session 346. For example, a shared shopping session 346 may include only a schedule 348 or only a schedule 348 and a sales associate identifier 312 upon creation with identifiers of other entities added later.

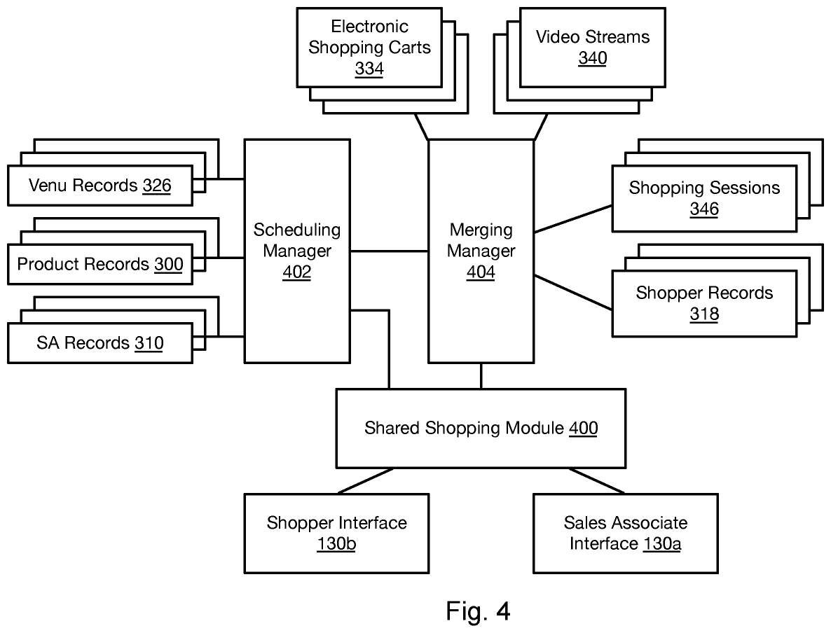

Referring to FIG. 4, a shared shopping module 400 executing on the server system 102 may interact with the shared shopping interface 130, such as a version of the shopping interface 130 presented on the user computing device (shopper interface 130a) and a version presented on the SA device 112 (sales associate interface 130b).

The shared shopping module 400 may interface with a scheduling manager 402 and a merging manager 404. For example, the shared shopping module 400 may receive a request to start and/or join a shared shopping session 346 in response to interaction with an interface 150b, receiving a request for a URL referencing a shared shopping session, or other interaction. In response, the shared shopping module 400 may obtain information for the shared shopping session 346 referenced by the request, such as information included in an entry described above with respect to the interface 150.

The shared shopping module 400 may interact with a scheduling manager 402. The scheduling manager 402 may manage the scheduling of a venue, one or more products, and a sales associate associated with a shared shopping session 346. For example, a plurality of requests may be received from a plurality of shoppers, each request referencing one or more product records 300. The scheduling manager 400 may evaluate the inventory schedule 308 of the one or more product records 300, the sales associate schedules 316 of one or more sales associate records 310, shopper schedules 324 (e.g., proposed date and times or ranges of dates and/or times requested by the shopper making the request), and the schedules 332 of one or more venue records 326. The scheduling manager 400 may then generate a tuple of one or more product identifiers 302, a sales associated identifier 312, one or more shopper identifiers 320, and a venue identifier 328 for each request. The tuple references a sales associate, venue, and unit of a product referenced by the product record that are available at the date and time of the request (or within a tolerance of the time of the request or within a range of dates and/or times specified in the request) according to the schedules evaluated by the scheduling manager. A plurality of tuples may be generated as a batch in order to coordinate scheduling of sales associates, units of products, and venues to avoid conflicts and improve utilization of these entities. The tuple of entities scheduled by the scheduling manager 402 and the date and time determined by the scheduling manager may be associated with a shopping session 346 by the scheduling manager 402. This may include adding references to the entities to the shopping session 346. Schedules of the entities assigned to the shared shopping session 346 may also be updated to indicate that they are unavailable at the date and time at which the shopping session 346 is scheduled for the scheduled duration (e.g., ½ hour, one hour, etc.) of the shopping session 346.

Upon receiving a request to join or start a shared shopping session having an associated record 346, the identifiers included in the tuple associated with the shared shopping session record 346 may be retrieved by the shared shopping module 400. The shared shopping module 400 may then use this information to, for example, notify a sales associate (e.g., via the sales associated device 112) or other person to bring products identified in the tuple to the venue identified in the tuple at or before the scheduled time for the shared shopping session.

The shared shopping module 400 may further invoke creating of one or more electronic shopping carts 334 for the shoppers associated with the share shopping session. These shopping carts 334 may have been previously created and associated with the shopper records 318 of the shoppers identified by the shared shopping session record 346 or from whom the request for a shared shopping session was received. The shared shopping module 400 may further invoke initiation of one or more video streams 340, such as streams of audio-visual data from the user computing device 110 and SA device 112 (e.g., from the one or more cameras 114, 116). For example, the devices 110, 112 may be associated with a shopper record 318 and sales associated record 310, respectively, identified by the tuple such that the share shopping module 400 may coordinate with the interfaces 130a, 130b on these devices to create the video streams 340. If not previously created, the shared shopping module 400 may also create a shared shopping record 346 for the shared shopping session.

The shared shopping module 400 may invoke a merging manager 404. The video streams 340, electronic shopping carts 334, and shared shopping session 346 may be created by different tools, APIs, or operating system functions and may need to be associated with one another. Accordingly, the merging manager 404 may associate objects implementing the video streams 340, electronic shopping carts 334, and shared shopping session 346 with one another. This may include associating identifiers of these entities (e.g., identifiers 342, 338) with the shared shopping session 346. The identifiers 342, 338 may be pointers, handles, or other type of identifier. The merging manager 404 may perform its function by invoking the tool, API, or operating system function to create these entities and associate objects (i.e., object pointers, handles, etc.) returned as a result with the shared shopping session 346.

Following merging, the shared shopping module 400 may manage the entities merged with the shared shopping session 346. This may include adding products to an electronic shopping cart 334, checking out an electronic shopping cart 334, displaying video streams 340 of the interfaces 130a, 130b, and performing other functions described herein.

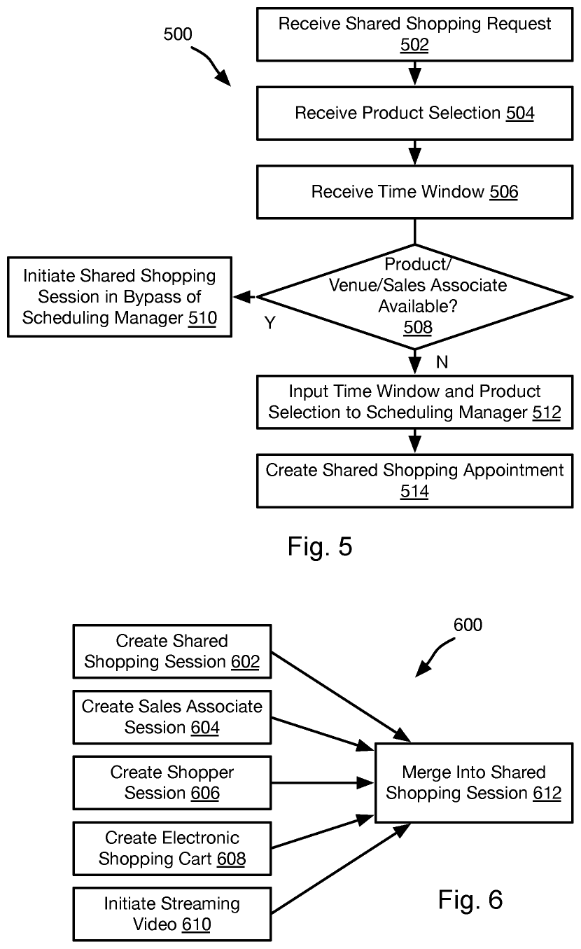

FIG. 5 illustrates a method 500 for initiating a shared shopping session 346. The method 500 may be executed by the server system 102, such as by the shared shopping module 400. The method 500 may include receiving 502 a request for shared shopping session from the user computing device 110 of a shopper, such as in the form of a request for a URL or interaction with an element of the interface 130a. In some embodiments, a sales associate may initiate a shared shopping session 346 without first receiving 502 a request. For example, while browsing a website, a real time interactive element may be displayed on the website, such as a video feed, chat window, or other interface. The real time interactive element may enable the sales associate to greet the shopper and invite the shopper to join the shared shopping session 346. The shopper may accept the invitation by, for example, clicking on the real time interactive element or other user interface element presented with the real time interactive element.

The method 500 may include receiving 504 a selection of one or more products that the shopper wishes for a sales associate to present during the shared shopping session. The selection may be received by interaction with a website including category webpages, searching functions, product webpages, blog articles, or other webpages presenting products and including interface elements enabling the shopper to select products and add references to corresponding product records 300 to a list of products to be discussed during a shared shopping session.

The method 500 may include receiving 506 a time window. The time window may be a specific time and date with an implied window including a range of times before and after the specific time and date. The time window may be specified as a start time and date and an end time and date between which the shopper is available to conduct a shared shopping session.

The method 500 may include evaluating 508 whether a unit of each product received step 502 is available and whether a sales associate and a venue are available for time window specified, the sales associate and venue may be those located at a same facility (e.g., same retail location) as the units of each product. In some embodiments, step 508 is performed only if the time window overlaps a threshold time from the time step 508 is performed, e.g. within 15 minutes, within half an hour, or some other value.

If the result of the evaluation at step 508 is positive, then a shared shopping session 346 is initiated 510 in bypass of the scheduling manager 402 with the sales associate and venue identified during the evaluation of step 508. This may include performing some or all of the functions described above with respect to FIG. 4 as being performed by the shared shopping module 400 to initiate a share shopping session 346.

If the evaluation of step 508 is negative, then the time window and identifiers of the products selected at step 504 may be input 512 to the scheduling manager 402. Step 504 may be performed for multiple requests. The method 500 then includes creating 514 shared shopping appointments for the one or more requests. As described above, this may be performed for multiple requests in order to improve utilization of venues, sales associates, and available product inventory.

FIG. 6 illustrates a method 600 for merging various data structures into a shared shopping session 346. The method 600 may be executed on the server system 102, such as by one or both of the shared shopping module 400 and merging manager 404.

The method 600 may include creating 602 a shared shopping session 346 in response to a request from and, in some embodiments, in response to an instruction from a sales associate to initiate the shared shopping session 346. The method 600 may include creating 604 a sales associate session and creating 606 a shopper session. This may include creating a session for interacting with the interfaces 130a, 130b of the shopper and sales associate. A session may be implemented according to a standard protocol (e.g., HTTP, TCP, etc.) or proprietary protocol and may have an associated network connection to the devices 110, 112 displaying the interfaces 130a, 130b. Each session may define data structures for exchanging information between the devices 110, 112 and the server system 102 and associating this information with the shared shopping session 346.

The method 600 may include creating 608 one or more electronic shopping carts 334, such as one or more for each shopper participating in the shared shopping session. Various solutions (e.g., software packages, APIs, etc.) exist for implementing ecommerce functions. Accordingly, creating 608 one or more electronic shopping carts may include instructing one of such solutions to create the one or more electronic shopping carts and receiving in response references to the one or more electronic shopping carts that may then be used to perform functions (adding and removing items, checking out, etc.) with respect to the one or more electronic shopping carts.

The method 600 may include initiating 610 one or more video streams (e.g., audio-visual streams) 340 from one or both of the devices 110, 112 of one or more shoppers and a sales associate participating in the shared shopping session. The devices 110, 112 may be identified due to the sessions previously created at steps 604 and 606 and video streams 340 may be initiated within the sessions from steps 604 and 606.

The method 600 may include merging 612 the sessions created at steps 604 and 606, the one or more electronic shopping carts 334 created at step 608, and the one or more video streams 340 from step 610 with the shared shopping session 346 from step 602. Merging may include associating objects representing the merged entities with the shared shopping session 346. In this manner, a video stream 340 of a device 110 may be routed to the device 112 that is part of the same shared shopping session, and vice versa. Likewise, interactions with the interfaces 130a, 130b on the devices 110, 112 may be processed by the server system 102 with respect to the entities that are part of the shared shopping session 346 (e.g., adding products to an electronic shopping cart 334, checking out, etc.).

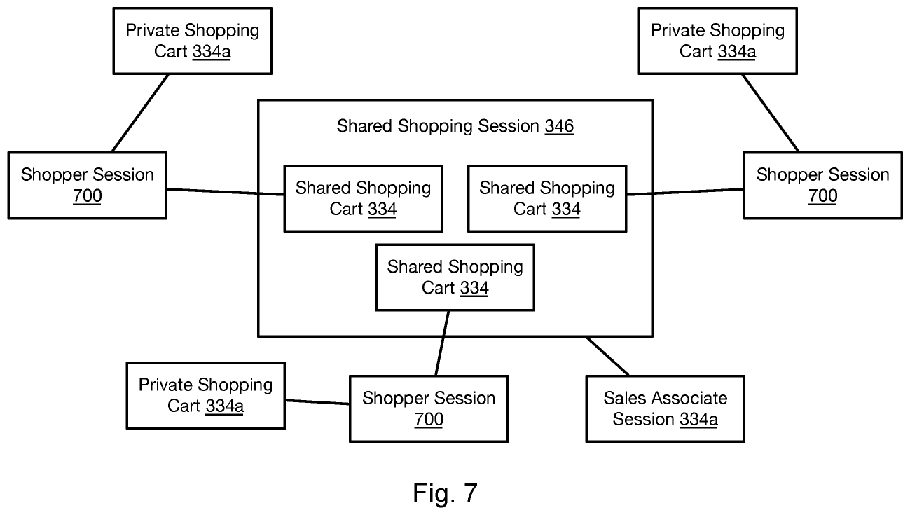

Referring to FIG. 7, there may be multiple shoppers in a shared shopping session 346. Each may have a shopper session 700 as discussed above. Each may also have a corresponding electronic shopping cart 334 associated with the shared shopping session 346. The electronic shopping carts 334 may be viewable in the interfaces 130a, 130b of other shoppers and the sales associate. The electronic shopping carts 334 may be manageable by the sales associate who may add and remove items and initiate checkout on behalf of a shopper corresponding to an electronic shopping cart 334. For example, the shopper may read out payment information that is entered by the sales associate in order to process payment.

In some embodiments, each shopper may have another shopping cart 334a associated with the session 700 of the shopper. The shopping cart 334a may be private and not viewable by other shoppers in the shared shopping session 346. For example, a representation of the private shopping cart 334a of a shopper may be displayed on the interface 130b of the shopper but not the interfaces 130b of other shoppers. The private shopping cart 334a of each shopper may also be non-viewable by the sales associate conducting the shared shopping session 346. The shopper may add items to the shopper's private shopping cart 334a and checkout the added items during the shared shopping session. In some embodiments, the private shopping cart 334a exists prior to creation of the shared shopping session 346 and may persist after ending of the shared shopping session 346.

Multiple shoppers may join a shared shopping session 346 by various means. A request may reference multiple shoppers such that all referenced shoppers are added to the shared shopping session 346 created in response to the request. In some embodiments, a shopper that made a request may share a link (e.g., URL) to the shared shopping session 346 such that upon receiving a request including the link from another shopper, that shopper is added to the shared shopping session 346.

Note that a celebrity may stream a shared shopping session 346 such that members of the public or invited guests may view the video streams and interface 130b but not have permission to add or remove items from the electronic shopping cart 334 and may or may not provide a video stream 340 to the shared shopping session 346. For example, streaming of a shared shopping session 346 to others may be conditioned on payment of a fee.

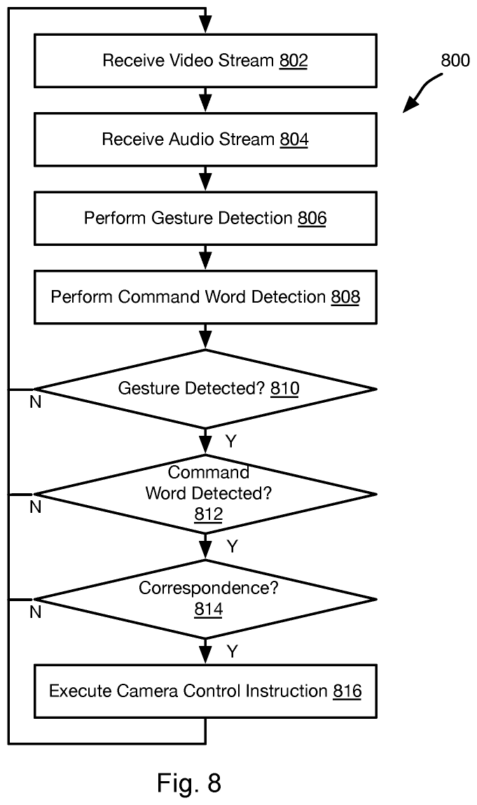

FIG. 8 illustrates a method 800 for a sales associate to control operation of a venue. The method 800 may be performed on the SA device 112 or on the server system 102 with respect to the SA device 112. The method 800 may include receiving 802 one or more video streams from the venue, such as video streams from the one or more cameras 114, 116. The method 800 may include receiving 804 one or more audio streams, such as from one or more microphones 122

The method 800 may include performing gesture detection 806 with respect to the one or more video streams and performing 808 command word detection with respect to the one or more audio streams. If a predefined gesture is found 810 to have been detected, a predefined command word is found 812 to be detected, and the detected gesture and detected command word are found 814 to correspond to one another, a control instruction may be executed 816, the control instruction being mapped to the detected combination of the gesture and the command word. A command word may be a single word or a phrase of multiple words. The control instruction may be an instruction to control the cameras 114, 116, such as to specify which camera 114, 116 is to supply video data for the video stream 340 of the sales associate. For example, a gesture may be used for all voice commands and a command word may be found to correspond to the gesture if it occurred within a threshold time of the gesture occurring or while the gesture was occurring. In other implementations, each control instruction has a unique gesture and command word mapped thereto. Gestures may include hand movements, facial expressions, arm movements, or other detectable positioning of any member of the sales associate.

For example, the sales associate may point downwardly and say “let's get a close-up” in order to switch to the camera 116. The sales associate may say, “let's get a wide shot” while waving outwardly in order to switch to the camera 114.

Command word and gesture combinations may be mapped to instructions for changing function of the lights 120, speaker 124, or other aspect of the interface 130a, such as adding of products to an electronic shopping cart 334, checking out an electronic shopping cart, muting the microphone 122, pausing streaming from one or both of the cameras 114, 116, or performing other functions.

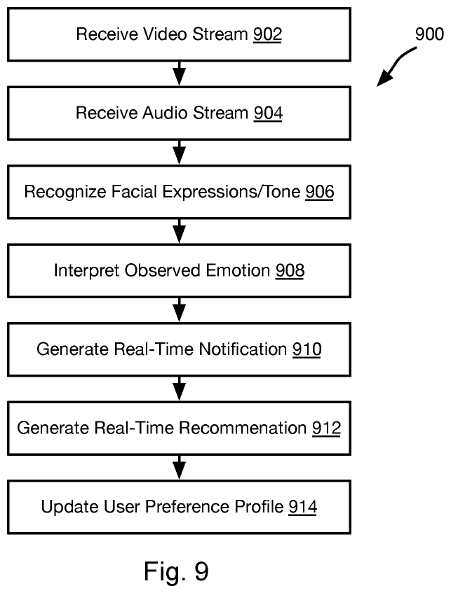

FIG. 9 illustrates method 900 that may be executed by the server system 102 during a shared shopping session. The method 900 may include receiving 902 a video stream and receiving 904 an audio stream from the shopper device 110, such as in the form of a video stream 340 embodied as an audio-visual stream.

The method 900 may include recognizing 906 some or all of facial expressions, body language, and tone of voice from the video stream and audio stream. The manner in which these are detected may be according to any approach known in the art. The method 900 may include interpreting 908 an emotion of a shopper represented in the video stream and audio stream based on what was detected at step 906.

The method 900 may include generating 910 a real-time notification to the sales associate, i.e., output on a screen, speaker, or other output device connected to the SA device 112. The notification may be related to the emotion interpreted at step 906. For example, if the sales associate is discussing, presenting, or demonstrating a product, the real-time notification may indicate that a shopper is or is not interested in the product where the emotion interpreted at step 908 is positive or negative, respectively. As used herein “real time” may be understood as during the shared shopping session and within 5 seconds of when the portion of the video stream and/or audio stream including the features identified at step 906 was received.

The method 900 may include generating 912 real-time recommendations. For example, where a positive emotion is interpreted at step 908, step 912 may include generating 912 a recommendation for a similar product to the product which the sales associate is currently presenting, an accessory to the product, an item having similar attributes (e.g., color, material, etc.), or another product selected based on another criteria. If the emotion is negative, the recommendation may be for a product that is dissimilar (different color, different material, etc.) than the product that is currently being presented. The recommendation may be generated 912 based on the interpreted emotion, attributes of the product currently being presented, and other data, such as past browsing or purchasing activity of the shopper, demographic attributes of the shopper, or other profile data.

The detected emotion from step 908 and the attributes of the currently presented product may also be used to update 914 a user preference profile of the shopper. The user preference profile may be a characterization of user preferences based on past purchases, browsing activity, or other activity. The positive or negative response to the currently presented product may therefore be used as another datapoint to characterize the preferences of the shopper.

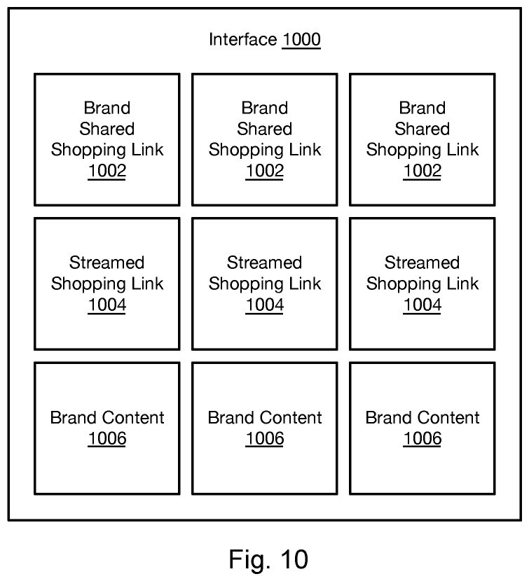

FIG. 10 illustrates an interface 1000 that may be used to request to join a shared shopping session and perform other functions. The interface 1000 may be transmitted by the server system 102 to the user computing device 110. The interface 1000 may be in the form of a webpage transmitted to a browser on the user computing device 110.

The interface 1000 may include interface elements 1002 including links such that, when the interface elements 1002 are selected by a shopper, the server system 102 initiates or schedules a shared shopping session for a brand, retailer, or other entity, according to the embodiments disclosed herein.

The interface 1000 may include interface elements 1004 including links such that, when the interface elements 1004 are selected by a shopper, the server system 102 causes a shared shopping session to be streamed to the shopper where the shared shopping session is that of another person, such as a celebrity. The shopper may view the interface 130b and streaming video displayed to the other person but not interact with the sales associate or perform other functions of a shopper in a shared shopping session as describe herein. The links may be in the form of a video or image.

The interface 1000 may include other interface elements 1006 including links such that, when the interface elements 1006 are selected by a shopper, the server system 102 causes display of other brand content on the computing device 110. This brand content may include videos, digital magazines, virtual reality content, or other digital content. The digital content displayed in response to selection of an element 1006 may include interface elements enabling a user to select products to add to an electronic shopping cart or preselect the products for use in a shared shopping session according to the embodiments disclosed herein.

The systems and methods disclosed herein may be used for the demonstration and sale of physical products by a sales associate. The sale of a physical product may be accompanied by sale of a token that authenticates the product and verifies that the purchaser is the owner of the product. The token may be embodied as a non-fungible token (NFT) or other data structure that is verified using a blockchain or other verification means. Digital assets (e.g., images, video files, audio files, etc.) may also be selected and sold using the systems and methods disclosed herein. Digital assets may likewise be accompanied by the creation of a token authenticating the digital asset and verifying purchase of the asset. Digital assets secured by NFTs may be paid for with cryptocurrency.

A marketplace for NFTs may be accessed using shared shopping according to the embodiments disclosed herein. Group shopping as disclosed herein may be performed with respect to NFTs. NFTs may be recommended to a user based on known user preferences with respect to physical products. NFTs may be marketed along with physical products in a live video stream and users may elect to purchase either according to the system and methods disclosed herein. As discussed above, the NFT may be used to authenticate and verify purchase of the physical product. The server system 102 may be configured to generate tokens for use with proprietary products developed by other entities. The system 102 may likewise be configured to verify and perform verified transfer of tokens in the marketplace.

The systems and methods disclosed herein may be adapted to coordinate the sale of products by multiple entities that may be legally and physically distinct. For example, the server system 102 may provide shared shopping sessions for multiple entities with separate ecommerce platforms or brands. The server system 102 may provide an interface to a sales associate to schedule appointments for multiple entities, schedule delivery of items from multiple entities for display on video during a shared shopping appointment, and perform checkout with respect to the multiple entities. The server system 102 may coordinate delivery with the multiple ecommerce platforms or brands such that products arrive substantially simultaneously (e.g., same day, same package, of same hour). Returns may likewise be coordinate such that returns for multiple ecommerce platforms or brands may be handled simultaneously, e.g. a single box for the returns. The server system 102 may combine appointments for multiple entities into a single appointment of a single sales associate. The server 200 may divide the appointment into segments, e.g. 20 minute segments of a one hour appointment, and assign each segment to one entity.

In one example implementation, the user device 110 is a smart TV or networked TV device (Apple TV, Roku, etc.) and may include an application for conducting shared shopping sessions with respect to one or more retailers. The smart TV may display video of a shopper (e.g., celebrity) participating in a shared shopping appointment, the video being broadcast and then received and displayed by the application. Accessed to the video of the shopper may be conditioned on payment. A user's account (e.g., AppleID) associated with the smart TV or networked TV device may be used by the server system 102 to access payment information and invoke purchase of items in response to user inputs according to the methods disclosed herein.

In another example implementation, a virtual newsstand may present virtual magazines including content in the form of text, images, and video. Text, image, or video may be associated (e.g., have an embedded URL) with a shared shopping appointment that will be populated with a particular product referenced by the text, image, or video. Such an interface may also enable a shopper to purchase a product directly, pin a product to a private or public forum, like a product, or perform other interactive browsing and shopping functions.

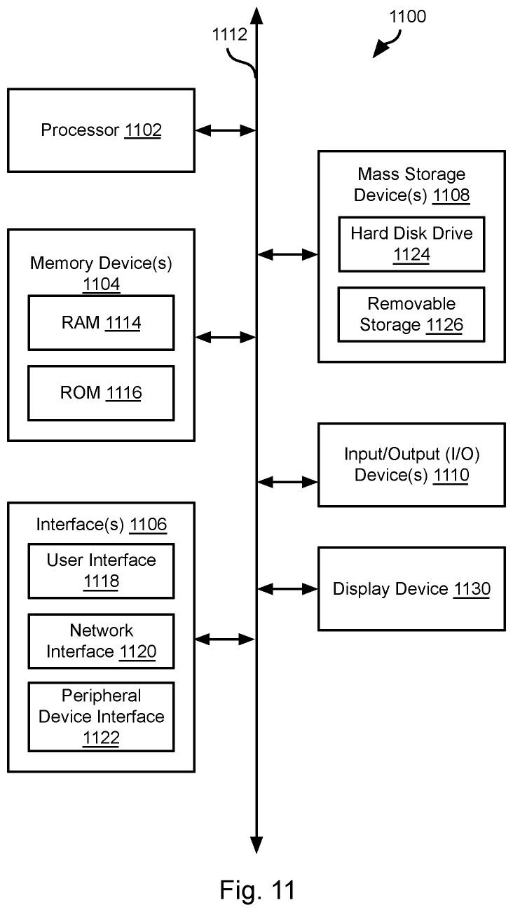

FIG. 11 is a block diagram illustrating an example computing device 1100. Computing device 1100 may be used to perform various procedures, such as those discussed herein. The server systems 102, 104 may each include one or more computing devices 1100 and a user device 110 and server device 112 may each be embodied as a computing device 1100.

Computing device 1100 includes one or more processor(s) 1102, one or more memory device(s) 1104, one or more interface(s) 1106, one or more mass storage device(s) 1108, one or more Input/Output (I/O) device(s) 1110, and a display device 1130 all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory. The processor 1102 may be embodied as or further include a graphics processing unit (GPU) including multiple processing cores.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 11, a particular mass storage device is a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, lenses, CCDs or other image capture devices, and the like.

Display device 1130 includes any type of device capable of displaying information to one or more users of computing device 1100. Examples of display device 1130 include a monitor, display terminal, video projection device, and the like.

Interface(s) 1106 include various interfaces that allow computing device 1100 to interact with other systems, devices, or computing environments. Example interface(s) 1106 include any number of different network interfaces 1120, such as interfaces to local area networks (LANs), wide area networks (WANs), wireless networks, and the Internet. Other interface(s) include user interface 1118 and peripheral device interface 1122. The interface(s) 1106 may also include one or more peripheral interfaces such as interfaces for printers, pointing devices (mice, track pad, etc.), keyboards, and the like.

Bus 1112 allows processor(s) 1102, memory device(s) 1104, interface(s) 1106, mass storage device(s) 1108, I/O device(s) 1110, and display device 1130 to communicate with one another, as well as other devices or components coupled to bus 1112. Bus 1112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

These example devices are provided herein purposes of illustration, and are not intended to be limiting. Embodiments of the present disclosure may be implemented in further types of devices, as would be known to persons skilled in the relevant art(s). At least some embodiments of the disclosure have been directed to computer program products comprising such logic (e.g., in the form of software) stored on any computer useable medium. Such software, when executed in one or more data processing devices, causes a device to operate as described herein.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method for facilitating shared shopping, the method comprising:
providing, by a server system, a shopper interface to a shared shopping session on a shopper device;
providing, by a server system, a sales associate interface to a shared shopping session on a sales associate device;
streaming, by the server system, video data from the sales associate device to the shopper interface on the shopper device;
receiving, by the server system, first control inputs from the sales associate device; and
adding, by the server system, one or more first products to an electronic shopping cart of a shopper associated with the shopper device in response to the first control inputs.

2. The method of claim 1, further comprising:
(a) determining, by the server system, that a sales associate device has not yet joined the shared shopping session;
in response to (a), presenting, by the server system, a pre-selection interface on the shopper device;
receiving, by the server system, pre-selection inputs through the pre-selection interface; and
adding, by the server system, references to one or more second products to the shopping cart in response to the pre-selection inputs.

3. The method of claim 2, further comprising:
(b) determining, by the server system, that the sales associate device has joined the shared shopping session; and
in response to (b), replacing, by the server system, the pre-selection interface with the shopper interface on the shopper device.

4. The method of claim 1, further comprising streaming the shopper interface to one or more other devices.

5. The method of claim 1, wherein the shopper device is a first shopper device and the electronic shopping cart is a first electronic shopping cart, the method further comprising:
connecting, by the server system, a second shopper device to the shared shopping session; and
associating, by the server system, a second shopping cart to the shared shopping session.

6. The method of claim 5, further comprising:
receiving, by the server system, second control inputs from the sales associate device; and
adding, by the server system, one or more second products to the second electronic shopping cart.

7. The method of claim 5, further comprising:
providing, by the server system, a first private electronic shopping cart associated with the first shopper device;
providing, by the server system, a second private electronic shopping cart associated with the second shopper device;
displaying, by the server system, contents of the second electronic shopping cart in the shopper interface on the first shopper device; and
refraining from displaying, by the server system, contents of the second private electronic shopping cart in the shopper interface on the first shopper device.

8. The method of claim 1, further comprising:
receiving, by the server system, a request to initiate the shared shopping session;
(a) determining, by the server system, that a sales associate device is available;
in response to (a), creating, by the server system, the shared shopping session.

9. The method of claim 1, further comprising:
receiving, by the server system, a request to initiate the shared shopping session;
(a) determining, by the server system, that a sales associate device is not available;
in response to (a), scheduling, by the server system, the shared shopping session.

10. The method of claim 1, wherein the request includes references to one or more products, the method further comprising:
identifying, by the server system, a time of availability of the sales associate device and the one or more products;
scheduling, by the server system, the shared shopping session for the time of availability.

11. The method of claim 1, further comprising:
analyzing, by the server system, the video data to determine an estimated emotion of the shopper; and
outputting, by the server system, a notification on the sales associate device corresponding to the estimated emotion.

12. The method of claim 11, wherein the notification includes a reference to a product selected according to the estimated emotion.

13. The method of claim 11, wherein the notification is output in real time.

14. The method of claim 1, wherein the sales associate device has a first camera and a second camera connected thereto, the video data being received from the first camera, the method further comprising:
evaluating, by the server system, the video data;
detecting, by the server system, a gesture in the video data;
in response to detecting the gesture, switching, by the server system, from the first camera to the second camera such that outputs of the second camera are streamed to the shopper interface.

15. The method of claim 14, wherein the sales associate device has a microphone connected thereto, the method comprising:
detecting, by the server system, a command word in an output of the microphone along with the gesture; and
switching, by the server system, from the first camera to the second camera in response to detecting both the command word and the gesture.

16. A system for facilitating shared shopping comprising:
one or more processing devices;
one or more memory devices connected to the one or more processing devices, the one or more processing devices storing executable code that, when executed by the one or more processing devices cause the one or more processing devices to:
provide a shopper interface to a shared shopping session on a shopper device;
provide a sales associate interface to a shared shopping session on a sales associate device;
stream video data from the sales associate device to the shopper interface on the shopper device;
receive first control inputs from the sales associate device; and
add one or more first products to an electronic shopping cart of a shopper associated with the shopper device in response to the first control inputs.

17. The system of claim 16, wherein the executable code, when executed by the one or more processing devices further causes the one or more processing devices to:
evaluate whether (a) that a sales associate device has not yet joined the shared shopping session;
if (a) is true:
present a pre-selection interface on the shopper device;
receive pre-selection inputs through the pre-selection interface; and
add references to one or more second products to the shopping cart in response to the pre-selection inputs.

18. The system of claim 17, wherein the executable code, when executed by the one or more processing devices further causes the one or more processing devices to:
evaluate whether (b) the sales associate device has joined the shared shopping session; and
if (b) is true, replace the pre-selection interface with the shopper interface on the shopper device.

19. The system of claim 16, wherein the shopper device is a first shopper device and the electronic shopping cart is a first electronic shopping cart;
wherein the executable code, when executed by the one or more processing devices further causes the one or more processing devices to:
connect a second shopper device to the shared shopping session; and
associate a second shopping cart to the shared shopping session.

20. The system of claim 16, wherein the executable code, when executed by the one or more processing devices further causes the one or more processing devices to
analyze the video data to determine an estimated emotion of the shopper; and
output a notification on the sales associate device corresponding to the estimated emotion.
